(19) United States
(12) Patent Application Publication
(10) Pub. No.: US 2024/0067155 A1
(43) Pub. Date: Feb. 29, 2024

(54) BATTERY PACK CONTROL APPARATUS, BATTERY PACK CONTROL METHOD, AND NON-TRANSITORY COMPUTER RECORDING MEDIUM INCLUDING BATTERY PACK CONTROL PROGRAM

(71) Applicant: PRIMEARTH EV ENERGY CO., LTD., Kosai-shi (JP)

(72) Inventor: Yuya INAGAKI, Okazaki-shi (JP)

(21) Appl. No.: 18/169,092

(22) Filed: Feb. 14, 2023

(30) Foreign Application Priority Data
Aug. 30, 2022 (JP) 2022-136445

(51) Int. Cl. B60W 10/26; B60L 58/12; B60L 58/16; B60L 58/20; B60R 16/04

(52) U.S. Cl. CPC B60W 10/26; B60L 58/12; B60L 58/16; B60L 58/20; B60R 16/04; B60W 2510/244

(57) ABSTRACT

A battery pack control apparatus according to an aspect of the present disclosure includes a plurality of selection switches respectively connected to a lowest voltage node and a highest voltage node of each of a plurality of battery cell groups set for each successive predetermined number of battery cells among the plurality of battery cells, a battery selection control unit configured to control on and off of the plurality of selection switches so as to select the battery cell group including the battery cell whose characteristic variation is large compared to those of other battery cells, and a low-voltage output unit configured to use the battery cell group selected by the battery selection control unit to output low-voltage power with a voltage value lower than that of the high-voltage power.

### INCORPORATION BY REFERENCE

This application is based upon and claims the benefit of priority from Japanese patent application No. 2022-136445, filed on Aug. 30, 2022, the disclosure of which is incorporated herein in its entirety by reference.

### BACKGROUND

The present disclosure relates, for example, to a battery pack control apparatus, a battery pack control method, and a non-transitory computer recording medium including a battery pack control program for controlling a battery pack that supplies power to a vehicle.

A vehicle including a drive motor is equipped with a drive battery that supplies power to the drive motor. A vehicle including such a drive battery is also equipped with an auxiliary battery to drive auxiliary equipment provided near an engine and the drive motor. By combining such batteries with different output characteristics, a wide range of output requirements can be satisfied. Techniques related to battery systems for responding to a wide range of output requirements by combining a plurality of batteries are disclosed in Published Japanese Translation of PCT International Publication for Patent Application, No. 2010-539635, Japanese Unexamined Patent Application Publication No. 2017-212803, and International Patent Publication No. WO2019/186659.

The hybrid energy storage system described in Japanese Patent Publication No. 2010-539635 may be used in a vehicle having a partial or completely electrified drivetrain. The hybrid energy storage system includes a first energy storage module and a second energy storage module, the first energy storage module being different from the second energy storage module. The modules include a cell or set of cells having common specific characteristics, such as cell configuration, cell chemistry, control and the like. The system is composed of two different modules, so that distinct electrochemistries, configurations, controls and the like, are included in the system.

The power supply system described in Japanese Patent Japanese Unexamined Patent Application No. 2017-212803 includes a secondary battery block in which lithium-ion battery cells and nickel-hydrogen battery cells are alternately arranged in a single row with heat conducting members between them, a power converter block in which a plurality of power converters individually connected to both terminals of each lithium-ion battery cell and each nickel-hydrogen battery cell are electrically connected in series, and a control apparatus that increases the charge/discharge power for the nickel-hydrogen battery cells so that it becomes greater than the charge/discharge power for the lithium-ion battery cells when the battery temperature is low, and increases the charge/discharge power for the lithium-ion battery cells so that it becomes greater than the charge/discharge power for the nickel-hydrogen battery cells when the temperature is high.

A power storage control device described in International Patent Publication No. WO 2019/186659 is to be used in a power storage system which combines a large-capacity power storage system having a first power storage device and a high-output power storage system having a second power storage device, the power storage control device being equipped with a deterioration state detection unit for detecting the state of deterioration of the first power storage device and the second power storage device, a demand power amount detection unit for detecting a demand power amount, which is the discharge power amount or the charge power amount required by the power storage system, and an allocation configuration unit for setting the allocated power amounts for the first and second power storage devices, on the basis of the demand power amount and the state of deterioration of the first and second power storage devices.

### SUMMARY

In Japanese Unexamined Patent Publication No. 2010-539635, the plurality of batteries provide an optimal power output environment in a wide range of operating environments. In Japanese Unexamined Patent Application Publication No. 2017-212803, charging and discharging limits are reduced compared with that in the installation of only nickel-metal hydride batteries or only lithium-ion batteries. In International Publication No. 2019/186659, charge/discharge power of both large-capacity and high-output power storage systems can be controlled so that deterioration of the power storage systems becomes uniform, thereby extending the life of the entire battery system. However, Published Japanese Translation of PCT International Publication for Patent Application, No. 2010-539635, Japanese Unexamined Patent Application Publication No. 2017-212803, and International Patent Publication No. WO 2019/186659 require a plurality of different batteries and have a problem that the size of the system is increased.

The present disclosure has been made in view of the above circumstances, and an object thereof is to supply output power with various voltages to a vehicle using a battery pack composed of a single type of battery cells.

An aspect of the present disclosure is a battery pack control apparatus for controlling a method of extracting power from a battery pack that is composed of a combination of a plurality of battery cells and supplies high-voltage power to a vehicle, the battery pack control apparatus including: a plurality of selection switches respectively connected to a lowest voltage node and a highest voltage node of each of a plurality of battery cell groups set for each successive predetermined number of battery cells among the plurality of battery cells; a battery selection control unit configured to control on and off of the plurality of selection switches so as to select the battery cell group including the battery cell whose characteristic variation is large compared to those of other battery cells; and a low-voltage output unit configured to use the battery cell group selected by the battery selection control unit to output low-voltage power with a voltage value lower than that of the high-voltage power.

Another aspect of the present disclosure is a battery pack control method for controlling a method of extracting power from a battery pack that is composed of a combination of a plurality of battery cells and supplies high-voltage power to a vehicle, the battery pack control method including: setting each of a plurality of battery cell groups for each successive predetermined number of battery cells among the plurality of battery cells; selecting the battery cell group including the battery cell whose characteristic variation is large compared to those of other battery cells; and using the selected battery cell group to output low-voltage power with a voltage value lower than that of the high-voltage power.

Another aspect of the present disclosure is a non-transitory computer readable medium storing a battery pack control program for causing an operation unit of a battery pack control apparatus for controlling a method of extracting power from a battery pack that is composed of a combination of a plurality of battery cells and supplies high-voltage power to a vehicle to execute: battery cell group setting processing for setting each of a plurality of battery cell groups for each successive predetermined number of battery cells among the plurality of battery cells; battery cell group selection processing for selecting the battery cell group including the battery cell whose characteristic variation is large compared to those of other battery cells; and low-voltage power output processing for using the selected battery cell group to output low-voltage power with a voltage value lower than that of the high-voltage power.

According to the battery pack control apparatus, the battery pack control method, and the battery pack control program of the present disclosure, it is possible to supply output power with various voltages to a vehicle using a battery pack composed of a single type of battery cells.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram of a battery pack control apparatus according to a first embodiment; and

FIG. 2 is a flowchart showing an operation of the battery pack control apparatus according to the first embodiment.

### DESCRIPTION OF EMBODIMENTS

For clarity of explanation, the following descriptions and drawings have been omitted and simplified as appropriate. In the above embodiments, each element described in the drawing as a functional block for performing various processes can be constituted by a CPU (Central Processing Unit), a memory, and other circuits in terms of hardware, and can b e implemented by a program loaded in a memory or the like in terms of software. Accordingly, it is understood by those skilled in the art that these functional blocks may be implemented in a variety of ways by hardware only, software only, or combinations thereof, and is not limited to either. In each drawing, the same elements are assigned the same symbols, and repeated descriptions are omitted as necessary.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

### First Embodiment

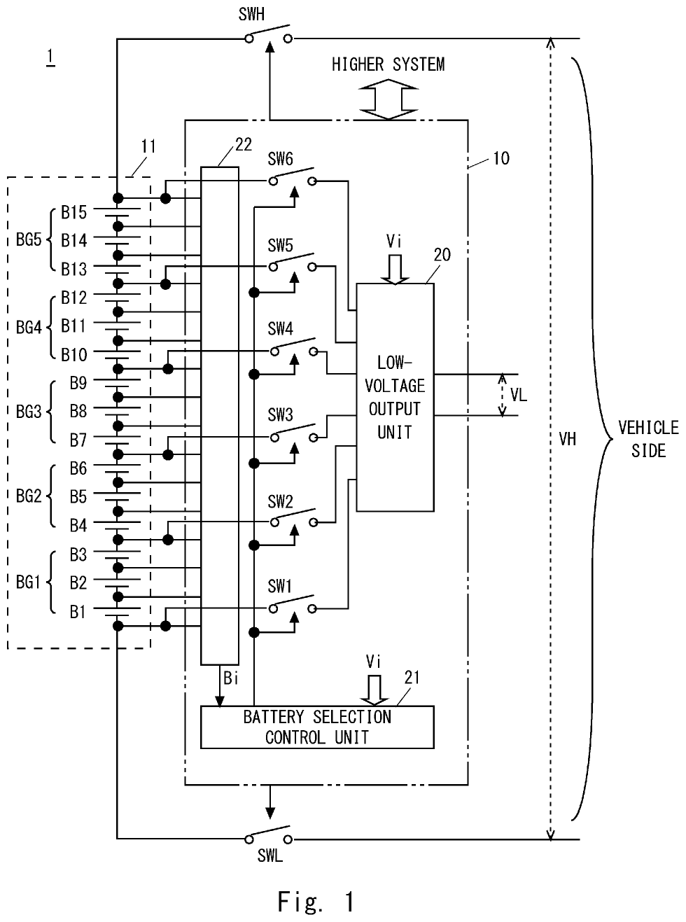

FIG. 1 is a block diagram of a battery pack control apparatus 10 according to a first embodiment. In order to understand a configuration of the battery pack control apparatus 10 in more detail, FIG. 1 shows the battery pack control apparatus 10 as a part of a battery system 1.

As shown in FIG. 1, the battery system 1 according to the first embodiment includes a battery pack control apparatus 10, a battery pack 11, and main relays SWH and SWL. The battery pack 11 is composed of a combination of a plurality of battery cells (in FIG. 1, battery cells B1 to B15) and supplies high-voltage power to a vehicle through wiring connected at both ends of the battery pack 11. More specifically, the battery pack 11 connects a single type of the battery cells B1 to B15 in series and outputs high-voltage power from both ends of the battery pack 11.

The main relay SWH is a relay switch provided on positive electrode wiring connected to a positive electrode of the battery pack 11. The main relay SWL is a relay switch provided on negative electrode wiring connected to a negative electrode of the battery pack 11. The battery pack control apparatus 10 communicates with a higher system provided on the vehicle side, which is to be supplied with the power, and controls the opening and closing of the main relays SWH and SWL to switch the supply and shutting off of the high-voltage power to the vehicle side. In FIG. 1, the voltage value of the high-voltage power is defined as a voltage value VH. In FIG. 1, the illustration of the processing block that performs processing to control the main relays SWH and SWL in the battery pack control apparatus 10 is omitted.

In addition to the main relay control function described above, the battery pack control apparatus 10 has a function of outputting low-voltage power having a voltage value (voltage value VL in FIG. 1) lower than that of the high-voltage power. In FIG. 1, a configuration related to low-voltage power output is selectively illustrated as an internal configuration of the battery pack control apparatus 10.

As shown in FIG. 1, the battery pack control apparatus 10 has a low-voltage output unit 20, a battery selection control unit 21, a battery characteristic acquisition unit 22, and selection switches SW1-SW6. The number of selection switches is the number of battery cell groups described later plus one. In the following description, an example in which a configuration of a battery cell group is fixed is described, but when the battery pack control apparatus 10 with a common hardware configuration is used while changing the configuration of the battery cells included in the battery cell group for each product type, the selection switches can be provided for all battery cells, for example, regardless of the number of battery cell groups.

First, when the battery pack control apparatus 10 is used, a battery cell group is set for each consecutive predetermined number of battery cells B1 to B15 included in the battery pack 11. In the example shown in FIG. 1, three battery cells that are consecutive in the direction of serial connection are set in one battery cell group, and five battery cell groups (e.g., battery cell groups BG1 to BG5) are set in the battery pack 11. Further, the selection switches SW1 to SW6 are connected to the highest voltage node and the nodes corresponding to the highest voltage node of the respective battery cell groups. The two selection switches SW1 and SW2 are described here. The selection switch SW1 is connected to the negative electrode node of the battery cell B1, which is the lowest voltage node of the battery cell group BG1. The selection switch SW2 is connected to the positive electrode node of the battery cell B3, which is the highest voltage node of the battery cell group BG1, and is also connected to the negative electrode node of the battery cell B3, which is the lowest voltage node of the battery cell group BG2. By connecting the selection switches SW1 to SW2 in this way, the battery cell group BG1 is selected by turning on the selection switches SW1 and SW2.

In addition, the number of battery cells included in one battery cell group is configured so that the total value of the output voltages of the battery cells when the battery cells included in one battery cell group are connected in series becomes a preset voltage value that is closest to the voltage value VL of the low-voltage power output by the low-voltage output unit 20. For example, if the output voltage of one battery cell is around 4 V and the required voltage value VL of the low-voltage power is 12 V, one battery cell group includes three battery cells.

The low-voltage output unit 20 outputs low-voltage power with a voltage value lower than that of the high-voltage power using the battery cell group selected by the battery selection control unit 21. The low-voltage output unit 20 may be a circuit wired to output the voltage given by the selected battery cell group as the voltage of the low-voltage power without modification, or it may output the low-voltage power using a regulator that fine-tunes the voltage given by the selected battery cell group.

The battery selection control unit 21 controls the on and off of the plurality of selection switches so as to select a battery cell group that includes battery cells whose characteristic variation is greater than that of other battery cells. The battery characteristic acquisition unit 22 acquires individual pieces of characteristic information Bi about the plurality of battery cells. The battery selection control unit 21 determines a battery cell group to select based on the characteristic information Bi acquired from the battery characteristic acquisition unit 22.

In the following description, an example in which the battery selection control unit 21 selects a battery cell group that includes at least one of a battery cell with low degradation, a battery cell with a high state of charge, and a battery cell with low-temperature startability from among the plurality of the battery cells B1 to B15 will be described. On the other hand, when there is no battery cell with low degradation, no battery cell with a high state of charge, or no battery cell with low-temperature startability among the plurality of the battery cells B1 to B15, the battery selection control unit 21 will determine a battery cell group to be selected according to a preset schedule.

Furthermore, the battery selection control unit 21 turns off the selection switch that has been turned on in response to receiving a notification from the vehicle side that activation of a low-voltage system utilizing the low-voltage power has been completed. The low-voltage output unit 20 also stops outputting the low-voltage power in response to receiving the notification from the vehicle side that the activation of the low-voltage system utilizing the low-voltage power has been completed. The battery pack control apparatus 10 switches the supply and stop of the low-voltage power according to instructions from a higher system prepared on the vehicle side. In the example shown in FIG. 1, the start of the supply of the low-voltage power and the notification that the activation of the low-voltage system has been completed are given, for example, as vehicle information Vi included in communication with the higher system.

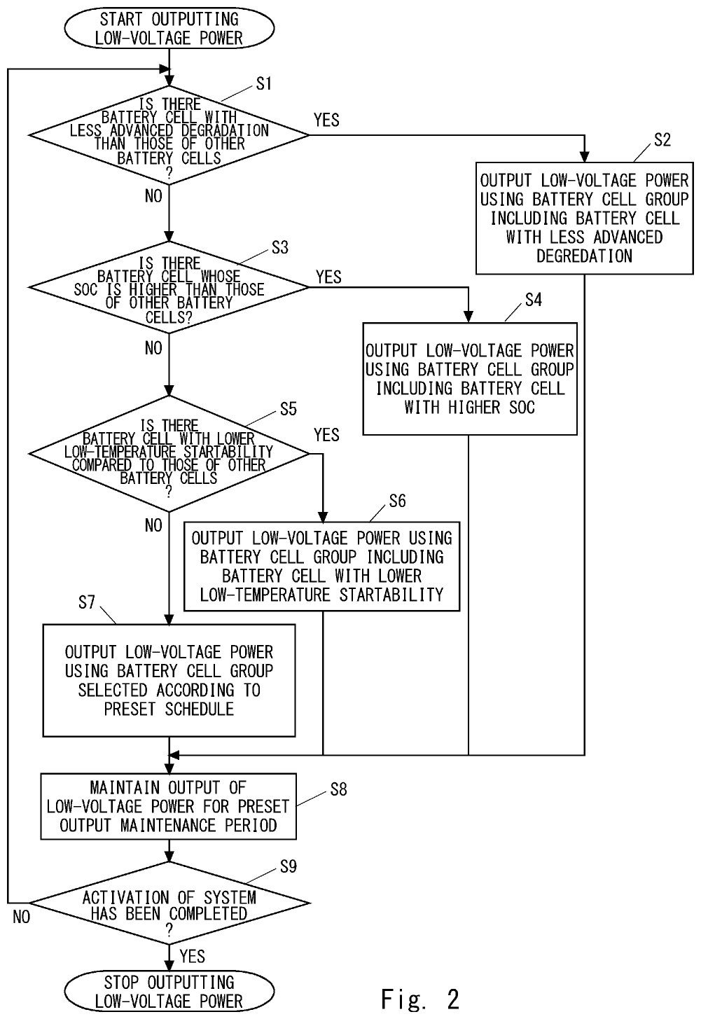

Next, an operation of the battery pack control apparatus 10 according to the first embodiment is described. FIG. 2 is flowchart showing the operation of the battery pack control apparatus according to the first embodiment. The flowchart of FIG. 2 shows the processing of the battery pack control apparatus 10 receiving an instruction from the higher system to start supplying the low-voltage power, starting the supply, and then stopping the output of the low-voltage power. However, the battery pack control apparatus 10 also performs other processing such as controlling the main relays SWH and SWL, and so on.

As shown in FIG. 2, the battery pack control apparatus 10 according to the first embodiment performs processing of determining the battery cell group to be selected by referring to the characteristic information Bi about the battery cells B1 to B15 when starting to output the low-voltage power in Steps S1 to S7.

In Step S1, degradation information about the battery cells B1 to B15 included in the characteristic information Bi is referred to in order to analyze whether there is a battery cell with less degradation than other battery cells. In Step S1, if there is a battery cell whose degradation is less advanced than those of the other battery cells, the battery selection control unit 21 controls the on and off of the selection switches SW1 to SW6 so that the battery cell group including the battery cell with less advanced degradation than those of the other battery cells is selected, and the low-voltage output unit 20 starts to output the low-voltage power using the selected battery cell group (Step S2).

On the other hand, if the degradation states of the battery cells B1 to B15 are almost the same in Step S1, the battery selection control unit 21 analyzes whether there is a battery cell whose State Of Charge (SOC) is higher than those of other battery cells (Step S3). If there is a battery cell whose SOC is higher than those of other battery cells in Step S3, the battery selection control unit 21 controls the on and off of the selection switches SW1 to SW6 so that the battery cell group including the battery cell with a higher SOC is selected, and the low-voltage output unit 20 starts to output the low-voltage power using the selected battery cell group (Step S4).

On the other hand, if the SOCs of the battery cells B1 to B15 are at approximately the same level in Step S3, the battery selection control unit 21 analyzes whether there is a battery cell with lower low-temperature startability compared to those of other battery cells (Step S5). Here, the low-temperature startability is an index indicating how easily an output drop due to the rise in the battery resistance is caused by the battery temperature being lower than temperatures of other batteries. For example, a battery cell positioned at the end of a battery stack, which are stacked battery cells, is susceptible to an influence from the external environment, and the battery temperature tends to become lower in a low-temperature environment, resulting in a low low-temperature startability. In Step S5, if there is a battery cell with lower low-temperature startability than that of the other battery cells, the battery selection control unit 21 controls the on and off of the selection switches SW1 to SW6 so that a battery cell group including the battery cell with lower low-temperature startability is selected, and the low-voltage output unit 20 starts to output the low-voltage power using the selected battery cell group (Step S6).

On the other hand, if the SOCs of the battery cells B1 to B15 are at approximately the same level in Step S5, the battery selection control unit 21 controls the on and off of the selection switches SW1 to SW6 so that the battery cell group selected according to the preset schedule is selected, and the low-voltage output unit 20 starts to output the low-voltage power using the selected battery cell group (Step S7).

After that, the battery selection control unit 21 and the low-voltage output unit 20 maintain the output of the low-voltage power for a preset output maintenance period (Step S8). After the output maintenance period has elapsed in Step S8, the battery selection control unit 21 and the low-voltage output unit 20 refer to the vehicle information Vi, checks whether or not activation of the system to which the low-voltage power is supplied has been completed, repeat the processing of Steps S1 to S8 until the activation of the system has been completed, and stop the output of the low-voltage power after the activation of the system has been completed (Step S9). When the output of the low-voltage power is stopped, the battery selection control unit 21 turns off all the selection switches (e.g., selection switches SW1 to SW6), and the low-voltage output unit 20 stops the operation and shifts an output terminal to a high-impedance state.

From the above description, the battery pack control apparatus 10 according to the first embodiment outputs the low-voltage power with a voltage value lower than that of the high-voltage power using a battery cell group composed of battery cells that are part of a battery pack composed of a plurality of battery cells connected in series. This enables the battery pack control apparatus 10 to output the low-voltage power with a voltage value lower than that of the high-voltage power without using additional batteries.

In addition, by using the battery pack control apparatus 10 according to the first embodiment, the low-voltage power can be supplied to the vehicle side without passing through the route for transmitting the high-voltage power to the vehicle. That is, by using the battery pack control apparatus 10 according to the first embodiment, low-voltage power can be supplied to the vehicle side even when the main relays SWH and SWL are turned off and the battery pack 11 is electrically disconnected from the vehicle.

For this reason, by using the battery pack control apparatus 10 according to the first embodiment, power can be supplied to the auxiliaries, for example, without providing a separate battery to supply power to the auxiliaries used to start an engine or a motor. That is, by using the battery pack control apparatus 10, batteries for the auxiliaries mounted on the vehicle can be reduced.

Furthermore, the battery pack control apparatus 10 according to the first embodiment determines the battery cell group to be used for the output of the low-voltage power so that the battery cells with a higher degree of deterioration and a larger variation of SOC than those of other battery cells are included. In this way, in the battery pack 11 controlled by the battery pack control apparatus 10, the degree of deterioration and the variation of SOC between battery cells can be reduced. Also, in the battery pack control apparatus 10 according to the first embodiment, by actively using battery cells with low low-temperature startability, the heating of the battery cells with low low-temperature startability can be promoted, and thus the low-temperature startability can be improved.

In the battery pack control apparatus 10, the above battery pack selection control unit 21 can also be implemented by using the battery selection control unit 21 as an operation unit capable of executing a program and causing the operation unit to execute the battery pack control program. This battery pack control program performs battery cell group setting processing, battery cell group selection processing, and low-voltage power output processing. In the battery cell group setting processing, each of a plurality of battery cell groups is set for successive predetermined number of battery cells among the plurality of battery cells. In the battery cell group selection processing, a battery cell group including a battery cell whose characteristic variation is greater than that of other battery cells is selected. When the battery cell group is selected, the low-voltage power output processing for outputting the low-voltage power with a voltage value lower than that of the high-voltage power using the selected battery cell group is achieved.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery pack control apparatus for controlling a method of extracting power from a battery pack that is composed of a combination of a plurality of battery cells and supplies high-voltage power to a vehicle, the battery pack control apparatus comprising:
a plurality of selection switches respectively connected to a lowest voltage node and a highest voltage node of each of a plurality of battery cell groups set for each successive predetermined number of battery cells among the plurality of battery cells;
a battery selection control unit configured to control on and off of the plurality of selection switches so as to select the battery cell group including the battery cell whose characteristic variation is large compared to those of other battery cells; and
a low-voltage output unit configured to use the battery cell group selected by the battery selection control unit to output low-voltage power with a voltage value lower than that of the high-voltage power.

2. The battery pack control apparatus according to claim 1, further comprising:
a battery characteristic acquisition unit configured to acquire individual characteristic information of the plurality of battery cells, wherein
the battery selection control unit is configured to determine the battery cell group to be selected based on the characteristic information acquired by the battery characteristic acquisition unit.

3. The battery pack control apparatus according to claim 1, wherein
the battery selection control unit is configured to turn off the selection switch that has been turned on in response to receiving a notification from the vehicle that activation of a low-voltage system utilizing the low-voltage power has been completed.

4. The battery pack control apparatus according to claim 1, wherein
the battery selection control unit is configured to select, among the plurality of battery cells, the battery cell group including at least one of the battery cell with low degradation, the battery cell with a high state of charge, and the battery cell with low-temperature startability.

5. The battery pack control apparatus according to claim 4, wherein
the battery selection control unit is configured to determine the battery cell group to be selected according to a preset schedule when there is no battery cell with low degradation, no battery cell with a high state of charge, or no battery cell with low-temperature startability among the plurality of battery cells.

6. The battery pack control apparatus according to claim 1, wherein
the number of battery cells included in the battery cell group is configured such that a total value of output voltages of the battery cells when the battery cells included in one battery cell group are connected in series is a preset voltage value that is closest to a voltage value of the low-voltage power output by the low-voltage output unit.

7. A battery pack control method for controlling a method of extracting power from a battery pack that is composed of a combination of a plurality of battery cells and supplies high-voltage power to a vehicle, the battery pack control method including:
setting each of a plurality of battery cell groups for each successive predetermined number of battery cells among the plurality of battery cells;
selecting the battery cell group including the battery cell whose characteristic variation is large compared to those of other battery cells; and
using the selected battery cell group to output low-voltage power with a voltage value lower than that of the high-voltage power.

8. A non-transitory computer readable medium storing a battery pack control program for causing an operation unit of a battery pack control apparatus for controlling a method of extracting power from a battery pack that is composed of a combination of a plurality of battery cells and supplies high-voltage power to a vehicle to execute:
battery cell group setting processing for setting each of a plurality of battery cell groups for each successive predetermined number of battery cells among the plurality of battery cells;
battery cell group selection processing for selecting the battery cell group including the battery cell whose characteristic variation is large compared to those of other battery cells; and
low-voltage power output processing for using the selected battery cell group to output low-voltage power with a voltage value lower than that of the high-voltage power.
